(19) United States
(12) Patent Application Publication
(10) Pub. No.: US 2026/0073639 A1
(43) Pub. Date: Mar. 12, 2026

(54) SYSTEMS AND METHODS FOR MARKER PLACEMENT IN AUGMENTED REALITY

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/826,822

(22) Filed: Sep. 6, 2024

(51) Int. Cl. G06T 19/00

(52) U.S. Cl. CPC G06T 19/006

(57) ABSTRACT

A system includes a position module configured to receive, from a phased antenna array, signals from one or more signal sources in an environment and determine, based on the signals, a location of each of the one or more signal sources in the environment relative to the phased antenna array; an AR marker module configured to identify each of the one or more signal sources for which identifying data is available and assign an AR marker to each of the one or more signal sources to produce AR-marked signal data; and a spatial awareness module configured to calculate a spatial position of each of the one or more signal sources with respect to at least one AR device and associate the spatial position of each of the one or more signal sources with the at least one AR device to produce AR device-specific tracking data.

### FIELD OF THE DISCLOSURE

The present disclosure is generally related to device tracking and more specifically to marker placement in augmented reality (AR).

### BACKGROUND

In large social gatherings, people often struggle to locate family, friends, or acquaintances within the crowd. This can lead to lost children, missed connections, and confusion. Phone tracking software can be used to keep track of individuals, but it is typically inaccurate and may not be effective if the individual is nearby but lost in a crowd or a hard-to-search area.

Initiating communication with unfamiliar individuals in a public setting is often difficult, as traditional methods require either knowing contact details in advance or physically approaching them. Many people prefer to meet friends or romantic partners spontaneously in public, and not on meetup apps, but still want to initiate a conversation digitally.

Finding likeminded individuals or interest groups is also difficult in public spaces. Identifying and connecting with others who share similar interests or professional backgrounds in the real world can expand networking opportunities and can offer a more personal connection than online groups.

### SUMMARY

The present disclosure includes a system and method for marker placement in AR that solves the problems and disadvantages of conventional approaches. According to one aspect, a system includes a phased antenna array and a position module configured to receive, from the phased antenna array, signals from one or more signal sources in an environment and determine, based on the signals, a location of each of the one or more signal sources in the environment relative to the phased antenna array. The system also includes an augmented reality (AR) marker module configured to identify each of the one or more signal sources for which identifying data is available and assign an AR marker to each of the one or more signal sources to produce AR-marked signal data. The system further includes a spatial awareness module configured to calculate a spatial position of each of the one or more signal sources with respect to at least one AR device and associate the spatial position of each of the one or more signal sources with the at least one AR device to produce AR device-specific tracking data. The system additionally includes a communication interface configured to transmit the AR-marked signal data and the AR device-specific tracking data to the at least one AR device for generation of an AR display.

In some embodiments, the position module determines the location of the one or more signal sources by triangulation and/or trilateration.

In some embodiments, the position module utilizes at least one of a Kalman filter, a Joint Probabilistic Data Association (JPDA) operation, or a Multiple Signal Classification (MUSIC) algorithm to determine the location of each of the one or more signal sources.

In some embodiments, the position module is configured to identify signal components of the signals from the one or more signal sources and assign the signals to tracks.

In some embodiments, the AR marker visually indicates information about at least one attribute of a respective signal source and is associated with graphical indicator that is displayed on a respective AR device.

In some embodiments, at least a subset of the one or more signal sources are registered devices, and wherein the phased antenna array is configured to connect to each registered device.

In some embodiments, the system further includes registration module configured to, in response to a request for a new registration from a user of the at least one AR device, prompt the user for registration information; and store the registration information in association with the at least one AR device.

In some embodiments, the system further includes a filter module configured to prompt a user for at least one data filter and filter the AR-marked signal data based on the at least one data filter before displaying one or more associated AR markers in the AR display.

In some embodiments, the at least one AR device includes a first AR device and a second AR device, and the system further includes an interaction request module configured to prompt a user of the first AR device for a recipient, identify the second AR device based on the recipient, send an interaction request to the recipient at the second AR device, and receive an acceptance or rejection of the interaction request.

In some embodiments, the system further includes connectivity module configured to initiate interaction between the first AR device and the second AR device in response to receipt of the acceptance.

According to another aspect, method includes receiving, from a phased antenna array, signals from one or more signal sources in an environment and determining, based on the signals, a location of each of the one or more signal sources in the environment relative to the phased antenna array. The method also includes identifying each of the one or more signal sources for which identifying data is available and assigning an AR marker to each of the one or more signal sources to produce AR-marked signal data. The method further includes calculating a spatial position of each of the one or more signal sources with respect to at least one AR device and associating the spatial position of each of the one or more signal sources with the at least one AR device to produce AR device-specific tracking data. In addition, the method includes transmitting, via a communication interface, the AR-marked signal data and the AR device-specific tracking data to the at least one AR device for generation of an AR display.

In some embodiments, determining the location of each of the one or more signal sources includes determining the location of each of the one or more signal sources using triangulation and/or trilateration.

In some embodiments, determining the location of each of the one or more signal sources includes using at least one of a Kalman filter, a Joint Probabilistic Data Association (JPDA) operation, or a Multiple Signal Classification (MUSIC) algorithm to determine the location of each of the one or more signal sources.

In some embodiments, determining the location of each of the one or more signal sources includes identify signal components of the signals from the one or more signal sources and assigning the signals to tracks.

In some embodiments, the AR marker visually indicates information about at least one attribute of a respective signal source and is associated with graphical indicator that is displayed on a respective AR device.

In some embodiments, at least a subset of the one or more signal sources are registered devices, and wherein the method includes connecting to each registered device via the phased antenna array.

In some embodiments, the method further includes, in response to a request for a new registration from a user of the at least one AR device, prompting the user for registration information and storing the registration information in association with the at least one AR device.

In some embodiments, the method further includes prompting a user for at least one data filter and filtering the AR-marked signal data based on the at least one data filter before displaying one or more associated AR markers in the AR display.

In some embodiments, the at least one AR device includes a first AR device and a second AR device, and the method further includes prompting a user of the first AR device for a recipient, identifying the second AR device based on the recipient, sending an interaction request to the recipient at the second AR device, and receiving an acceptance or rejection of the interaction request.

In some embodiments, the method further includes initiating interaction between the first AR device and the second AR device in response to receipt of the acceptance.

### BRIEF DESCRIPTION OF THE DRAWINGS

FIG. 1 is a schematic diagram of a phased array tracking system according to an embodiment.

FIG. 2 is a flowchart of a method performed by a Base Module according to an embodiment.

FIG. 3 is a flowchart of a method performed by an XYZ Position Module according to an embodiment.

FIG. 4 is a flowchart of a method performed by an AR Marker Module according to an embodiment.

FIG. 5 is a flowchart of a method performed by a Spatial Awareness Module according to an embodiment.

FIG. 6 is a flowchart of a method performed by a Base Module an Opt-in Module according to an embodiment.

FIG. 7 is a flowchart of a method performed by a Data Filtering Module according to an embodiment.

FIG. 8 is a flowchart of a method performed by an Interaction Request Module according to an embodiment.

FIG. 9 is a flowchart of a method performed by a Connectivity Module according to an embodiment.

FIG. 10 is a flowchart of a method performed a Targeted Ad Module according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

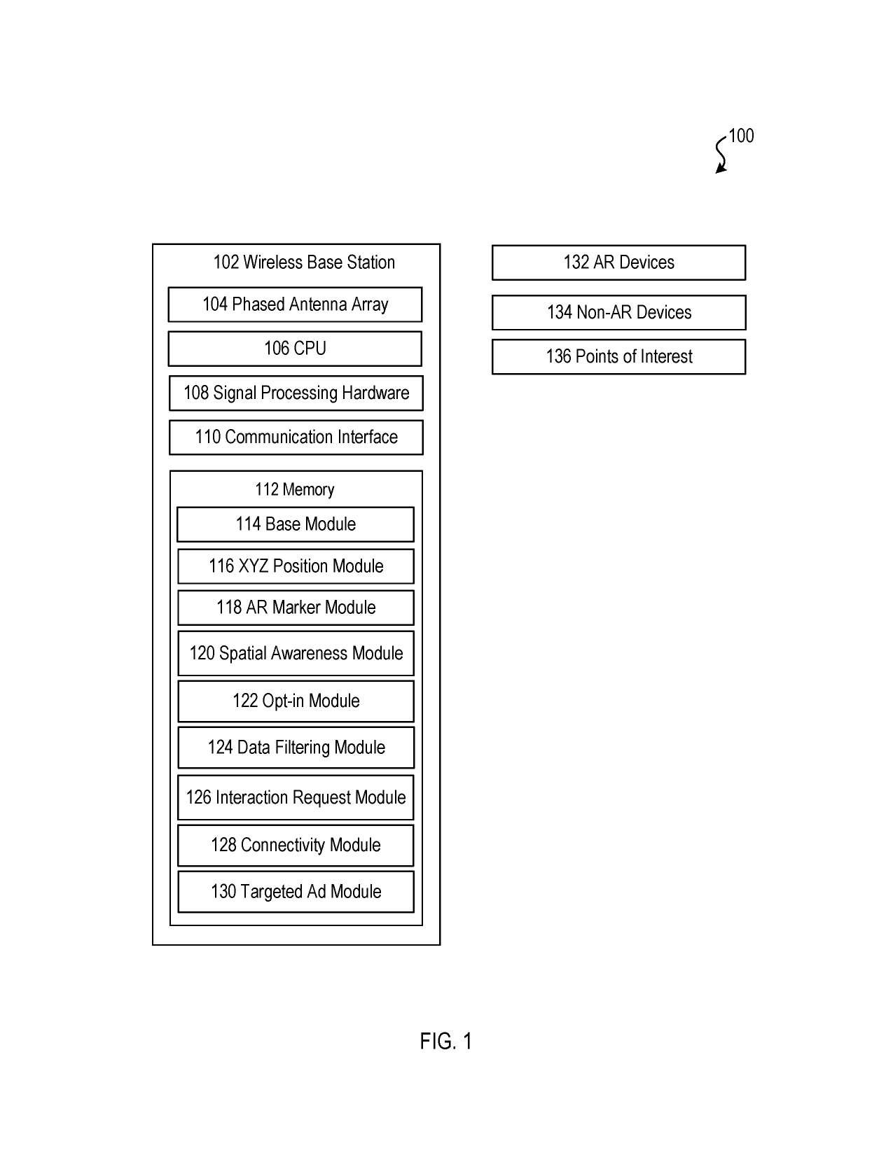

FIG. 1 is a schematic illustration of a phased array tracking system 100 (or “system 100”). The system 100 may include a wireless base station 102, which may track the location of one or more signal sources. The wireless base station 102 may also be a type of wireless router that allows for a Bluetooth, cellular, or other type of signal frequency connection or broadcast. In one embodiment, the wireless base station 102 may be for military grade synthetic aperture radar signals. The wireless base station 102 may include a phased antenna array 104 comprised of multiple individual antennas, each capable of transmitting and/or receiving electromagnetic signals. The wireless base station 102 may receive signals from one or more sources using the phased antenna array 104 and triangulate the location of the source using an angle of arrival (AoA) calculation based on the difference in phase and time of the received signals. The wireless base station 102 may have active and passive functionality, which may be separate modes or may both function simultaneously. Passive functionality may refer to only receiving signals from sources, whereas active functionality may refer to transmitting to a device in order to elicit a response.

In addition, or alternatively, the wireless base station 102 may use received signal strength to perform trilateration. Trilateration is an alternative method of determining the position of a signal source by calculating the distances between the source and multiple receiving antennas. Distance estimation can be performed using Angle of Arrival (AoA) data, where known positions of the antennas and the angles of the incoming signal are used to infer the distance. However, a more direct and sometimes more precise method may involve deriving the distance from the difference in signal strength received at two or more antennas. The principle behind this method is based on the inverse relationship between signal strength and distance. As the distance from the signal source to the antenna increases, the signal strength decreases, typically following an inverse-square law or a similar attenuation model depending on the environment. In scenarios where trilateration is implemented, the wireless base station 102 may use at least three antennas to determine the exact location of the signal source. The use of three antennas allows the formation of three independent distance equations, which, when solved simultaneously, may provide a unique intersection point corresponding to the location of the signal source. The received signal strength at each antenna may provide the basis for calculating the respective distances. For example, if the signal at one antenna is stronger by a known percentage compared to another, the ratio of these signal strengths can be used to infer the ratio of the distances. By combining this information with the known physical separation between the antennas, the system can establish a set of nonlinear equations representing the distances from the source to each antenna. The solution involves finding the point where the calculated distances (based on signal strength differences) intersect, which represents the most likely location of the signal source relative to the antenna array. Furthermore, the accuracy of trilateration can be enhanced by incorporating additional antennas, which provide more distance measurements and, consequently, reduce the uncertainty in the position estimate. The use of more antennas allows for the implementation of overdetermined systems, where the additional data can be used to minimize errors and improve the robustness of the location estimation process. Trilateration is particularly advantageous in environments where the AoA measurement might be challenging due to multipath propagation or other interference effects that distort the apparent AoA. Trilateration may be used in place of or in conjunction with triangulation.

In some embodiments, the wireless base station 102 uses the MUSIC (Multiple Signal Classification) algorithm. MUSIC utilizes the eigenvalues and eigenvectors of the covariance matrix of the received signal to estimate AoA with high resolution by searching for peaks in the spatial spectrum. To address complex environments, a Multiple Signal Classification (MUSIC) algorithm can be used. In signal processing problems, the objective is to estimate from past measurements or expectations of measurements from a set of constant values upon which the received signals depend.

Achieving centimeter-level accuracy in 3D mapping is useful for applications that provide precise positioning and spatial awareness. The system 100 is designed to provide this high level of precision, ensuring that positioning can be accurately determined within centimeter-level tolerances, or better, in 3D space. To enhance the capabilities of 3D mapping, the data obtained from the wireless base station 102 can be integrated with various other 3D mapping technologies. For instance, synthetic aperture radar (SAR) can be utilized to offer additional spatial data, leveraging its ability to produce high-resolution images and detect changes over time. Incorporating camera-based systems can provide visual context and details that may not be captured by the phased antenna array alone. Ultrasound technology can also be employed, especially in environments where optical or radar-based systems might face challenges, such as underwater or in densely cluttered areas. Additionally, LIDAR technology can be integrated to measure distances by illuminating targets with laser light and measuring the reflection with a sensor, which is useful in applications like autonomous vehicles and topographic mapping. Combining these technologies allows for a more comprehensive 3D mapping process, enhancing accuracy and applicability across various fields. For example, in urban planning, combining phased array data with LIDAR can create detailed city models. In agriculture, integrating data from SAR and drones can help in precise crop monitoring and land use planning. In search and rescue operations, combining ultrasound with phased array data can assist in locating individuals in challenging environments. This approach ensures that the 3D mapping solution is effective in a wide range of scenarios, meeting the diverse needs of different industries and applications.

The system 100 may further include a phased antenna array 104, which may be an array of antennas that receive and/or transmit at different phases. This phased antenna array 104 may include any combination of receiver antennas, transmitter antennas, and antennas capable of both receiving and transmitting signals, thereby providing versatile communication capabilities. The phased antenna array 104 may include at least one antenna capable of transmission for the active functions of the wireless base station 102, such as beamforming, signal amplification, and directed communication. The phased antenna array 104 may also include at least two antennas capable of receiving for the triangulation functions of the wireless base station 102. These receiving antennas facilitate precise location determination of signal sources through techniques such as angle of arrival (AoA) estimation. The antennas may be arranged in a specific geometric configuration, such as linear, circular, or planar arrays, and electronically connected such that their individual signal phases and amplitudes can be controlled. This electronic control enables the phased array to dynamically steer the beam direction, enhance signal strength, and reduce interference from unwanted sources. The phased antenna array 104 may incorporate signal processing algorithms to optimize its performance. These algorithms may include adaptive beamforming, which adjusts the phase and amplitude of each antenna element to maximize signal reception from desired directions while minimizing noise and interference. The phased antenna array 104 may also support multiple-input multiple-output (MIMO) technology, allowing simultaneous transmission and reception of multiple data streams, thereby increasing the overall data throughput and reliability of the system 100. The phased antenna array 104 may be integrated with a control unit that monitors and adjusts the operational parameters of each antenna element in real time. This control unit may utilize feedback mechanisms to dynamically adapt to changing environmental conditions and signal propagation characteristics, ensuring optimal performance under various scenarios. The integration of these features within the phased antenna array 104 enhances the system's capability to provide robust and efficient communication and precise triangulation of signal sources. The phased antenna array 104 may include a low noise amplifier (LNA) to amplify weak incoming signals from multiple antennas while minimizing noise. The LNA may include a number of channels which each correspond to a specific antenna in the phased array, enhancing sensitivity and accuracy. The phased antenna array 104 may be made from novel materials, such as graphene or metamaterials so as to deliver the increased sensitivity needed for certain applications.

The system 100 may further include a computer processing unit (CPU) 106, which may be configured to decode and execute any instructions received from one or more other electronic devices or server(s). The CPU 106 may include one or more general-purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The CPU 106 may be configured to execute one or more computer-readable program instructions, such as program instructions, to carry out any of the functions described in this description. The CPU 106 may be a GPU such as those produced by Nvidia®

The system 100 may further include signal processing hardware 108, which may refer to the physical components and devices specifically designed and configured to perform operations on signals to extract, enhance, manipulate, or interpret information. This hardware is helpful in various applications where signals, such as audio, video, or sensor data, provide real-time or near-real-time processing. Signal processing hardware 108 may include Analog-to-Digital Converters (ADCs), Digital-to-Analog Converters (DACs), Digital Signal Processors (DSPs), Field-Programmable Gate Arrays (FPGAs), and Application-Specific Integrated Circuits (ASICs)

The system 100 may further include a communication interface 110, which may be a set of hardware and/or software components that facilitate the exchange of data between different systems, devices, or components. The communication interface 110 serves as the conduit through which data is transmitted, received, and interpreted, ensuring seamless communication between the wireless base station 102, the AR devices 132, and the non-AR devices 134.

The system 100 may further include memory 112, which may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or another type of media/machine-readable medium suitable for storing electronic instructions. The memory may include modules implemented as a program.

The system 100 may further include a base module 114, which may connect to any AR devices 132 and non-AR devices 134, which are registered with the system 100 by users. The base module 114 may continuously collect data from the phased antenna array 104. The base module 114 may initiate the XYZ position module 116 to process the received signals and calculate an XYZ position for the source. After signal processing, the base module 114 may initiate the AR marker module 118 to identify the source of the signal and select the proper AR marker for the source. The base module 114 may initiate the spatial awareness module 120 to calculate the spatial position of each signal source and/or point of interest 136 with respect to each AR device 132. The base module 114 may initiate the opt-in module 122 to allow users to opt into being a user of the system 100. The base module 114 may initiate the data filtering module 124 to allow users to filter the AR markers for specific groups. The base module 114 may initiate the interaction request module 126 to allow users to send interaction requests to other devices. If an interaction request is accepted, the base module 114 may initiate the connectivity module 128 to facilitate communication between the two or more users. The base module 114 may initiate the targeted ad module 130 to send targeted advertisements to specific users based on their location.

The system 100 may further include an XYZ position module 116, which may process the signals received by the phased antenna array 104 in order to locate the source of the signal in 3-dimensional space. The XYZ position module 116 may utilize sophisticated computational techniques such as Kalman filters and joint probabilistic data association (JPDA) to accurately estimate device locations and track their movements while maintaining synchronization among multiple antennas for precise triangulation. The XYZ position module 116 may utilize a subnanosecond clock and a high-speed power meter for detecting the small differences in time between receiving a signal at two or more receiver antennas.

The system 100 may further include an augmented reality (AR) marker module 118, which may assign an AR marker to a signal source. The AR marker may visually indicate information about the signal source. If the source is registered with the system 100 as a user's device, the data about the user may also be indicated or displayed via the AR marker. AR marker data may be sent to the AR devices 132.

The system 100 may further include a spatial awareness module 120, which may calculate the spatial position of each signal source and/or point of interest 136 with respect to each AR device 132. The spatial awareness module 120 receives XYZ coordinate information from the base module 114, and for each AR device 132 moves the origin of these coordinates from the wireless base station 102 to the AR device 132. These new coordinates are sent to the AR devices 132 so that the AR markers can be displayed at the correct distance and direction.

The system 100 may further include an opt-in module 122, which may allow a person to opt into the system 100 for data visibility and interactions. Devices of persons who have not opted-in to the system 100 may still be tracked, but data from these devices may not be available to users, and the owners of these devices may not be able to view data about users or receive data from users.

The system 100 may further include a data filtering module 124, which may allow users to filter which data is displayed via the AR devices 132. Users may specify filtering criteria, such as friends, family, colleagues, specific groups, etc., and only those AR markers may be visible. Filter settings may be set via a mobile app or web portal. Filter settings may also be set via the AR device 132 via button inputs or detected gestures.

The system 100 may further include an interaction request module 126, which may allow users to send requests to interact with other users and/or devices. Unregistered devices may still be sent interaction requests, which may be associated with the device until the owner of that device opts into the system 100. A user who receives an interaction request can accept or reject the request.

The system 100 may further include a connectivity module 128, which may facilitate communication between two or more users once an interaction request has been accepted.

The system 100 may further include a targeted ad module 130, which may send targeted advertisements to specific users based on their location. Ad targeting may take into account information about the location, such as the nearby points of interest 136, nearby AR devices 132 and non-AR devices 134, the user's movement speed and direction, other users in the area, or any other factor which may affect the relevance of an ad.

The system 100 may further include one or more augmented reality (AR) devices 132, which may be devices capable of digital information in the real-world environment. The AR device 132 may include a display system, a sensor suite, a processing unit, and an interaction interface. The display system, which may include transparent or semi-transparent screens, head-mounted displays, or projection systems, may be designed to present visual data in conjunction with the user's natural surroundings. The sensor suite, which may consist of cameras, gyroscopes, accelerometers, and depth sensors, may be engineered to capture real-time environmental data and user interactions. The processing unit, which may encompass one or more microprocessors, graphics processing units (GPUs), and memory modules, may be configured to process the captured data, execute AR applications, and generate the digital overlays. The interaction interface, which may include touch sensors, voice recognition systems, or gesture recognition mechanisms, may be designed to facilitate user interaction with the augmented content. The AR device 132 may be operable in various modes, such as object recognition, spatial mapping, and contextual information display, thereby providing an enriched user experience by integrating virtual elements with the physical world in a seamless manner. The AR device 132 may further include communication modules to interface with external networks and devices, enhancing its functionality and applicability across multiple domains such as gaming, education, medical applications, and industrial operations.

The system 100 may further include one or more non-AR devices 134, which may be any devices that are not capable of AR but which still transmit a signal detectable by the wireless base station 102. This includes user devices such as a laptop, smartphone, tablet, computer, etc.

The system 100 may further include one or more points of interest 136, which may be locations that are not detected by the wireless base station 102 but have a known location and that may be of interest to users of the system 100. These points of interest may be real world objects or areas, such as a statue, restaurant, or park, or may be virtual objects or areas.

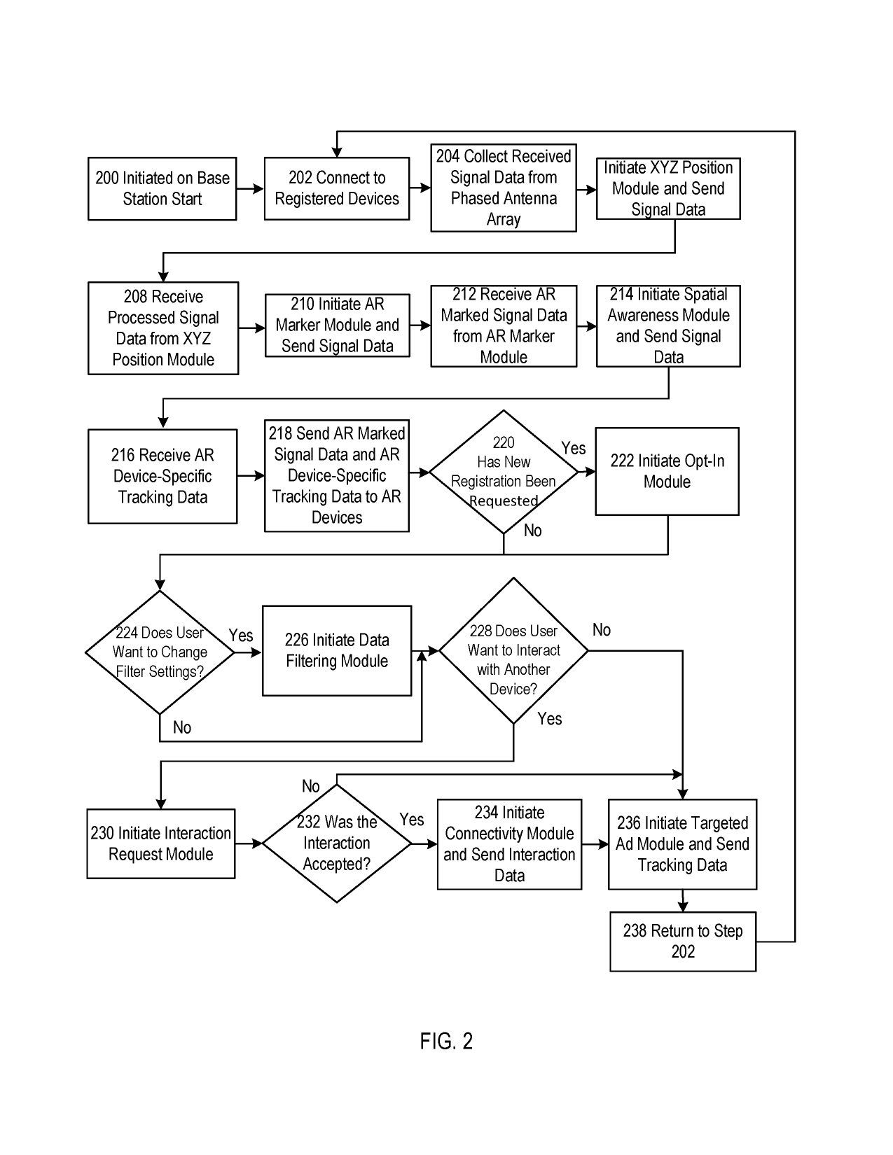

FIG. 2 illustrates an example operation of the base module 114. The base module 114 may be initiated at step 200 when the wireless base station 102 is powered on and/or activated. The base module 114 may connect at step 202 to any devices that have been registered with the system 100 via the opt-in module 122. This may include both AR devices 132 and non-AR devices 134. This connection may be made via the communication interface 110.

The base module 114 may collect at step 204 received signal data from the phased antenna array 104. Signal data may be data on signals received from one or more sources, such as an AR device 132 or a non-AR device 134. Signal data may include the waveform of the signal, the time received, the intensity of the signal, the phase of the signal, or any other property of the signal. Each antenna of the phased antenna array 104 may provide unique signal data.

The base module 114 may initiate at step 206 the XYZ position module 116 and send in the signal data. The XYZ position module 116 may process the signals received by the phased antenna array 104 in order to locate the source of the signal in 3-dimensional space. The XYZ position module 116 may utilize various computational techniques such as Kalman filters and joint probabilistic data association to accurately estimate device locations and track their movements while maintaining synchronization among multiple antennas for precise triangulation. The XYZ position module 116 may utilize a subnanosecond clock and a high-speed power meter for detecting the small differences in time between receiving a signal at two or more receiver antennas.

The base module 114 may receive at step 208 processed signal data from the XYZ position module 116. The signal data may include tracking data. This tracking data may include the calculated location of each signal source based on received signals. The data may also include metadata such as confidence level and margin of error. For example, the tracking data may include that an AR device 132 is at the coordinates (1348cm, 804cm, -52cm) and a non-AR device 134 is at the coordinates (1145m, 210cm, -30cm) where the origin (0,0,0) is the location of the wireless base station 102.

The base module 114 may initiate at step 210, the AR marker module 118. The AR marker module 118 may assign an AR marker to a signal source. The AR marker may visually indicate information about the signal source. If the source is registered with the system 100 as a user's device, the data about the user may also be indicated or displayed via the AR marker.

The base module 114 may receive at step 212 AR marked signal data from the AR marker module 118. Each signal source in the signal data may now have a marker associated with it. For example, a registered non-AR device 134, such as a user's cellphone, may receive a green phone icon as a marker. For another example, an unregistered non-AR device 134, such as a person's laptop, may receive a grey computer icon as a marker. For another example, a non-AR device 134, such as an RFID tag on a product at a store, may receive an icon that resembles that product. As such, a marker may convey at least one attribute of a signal source.

The base module 114 may initiate at step 214, the spatial awareness module 120. The spatial awareness module 120 may calculate the spatial position of each signal source and/or point of interest 136 with respect to each AR device 132. The spatial awareness module 120 receives XYZ coordinate information from the base module 114. For each AR device, 132 moves the origin of these coordinates from the wireless base station 102 to the AR device 132.

The base module 114 may receive at step 216 AR device 132 specific tracking data from the spatial awareness module 120. AR device 132 specific tracking data contains a set of tracking data for each connected AR device 132. The tracking data has been transformed for each specific AR device 132 such that the device is the origin of the data instead of the wireless base station 102. For example, the original tracking data included that an AR device 132 is at the coordinates (1348cm, 804cm, -52cm) and a non-AR device 134 is at the coordinates (1145m, 210cm, -30cm) where the origin (0,0,0) is the location of the wireless base station 102. The AR device 132 specific tracking data would have the AR device 132 at the origin (0,0,0), the wireless base station at (-1348cm, -804cm, 52cm), and the non-AR device 134 at (-203cm, -594cm, 22cm).

The base module 114 may send at step 218 the AR marked signal data and the AR device 132 specific tracking data to the respective connected AR devices 132. The AR marked signal data informs the AR device 132 of which markers to display for which signal sources. The AR device 132 specific tracking data informs the AR device 132 of where other signal sources are in relation to the AR device 132. With both of these sets of data, the AR device 132 can display a graphical marker at the correct location to indicate to the user the identity and location of a signal source.

The base module 114 may determine at step 220 if new registration with the system 100 has been requested. For example, a person may request to register an AR device 132 with the system 100 using a web portal or mobile application.

If a new registration has been requested, the base module 114 may initiate at step 222 the opt-in module 122. The opt-in module 122 may allow a person to opt-in to the system 100 for data visibility and interactions. Devices of persons who have not opted-in to the system 100 may still be tracked, but data from these devices may not be available to users, and the owners of these devices may not be able to view data about users or receive data from users.

If a new registration has not been requested, the base module 114 may determine at step 224 if a user wants to change their filter settings. For example, a user may select "filter" from a settings menu on their AR device 132 or may make a hand gesture that the AR device 132 recognizes as a command to filter data.

If a user does want to change filter settings, the base module 114 may initiate at step 226, the data filtering module 124. The data filtering module 124 may allow users to filter which data is displayed via the AR devices 132. Users may specify filtering criteria, such as friends, family, colleagues, specific groups, etc., and only those AR markers may be visible.

If a user does not want to change filter settings, the base module 114 may determine at step 228 if a user wants to interact with another device user. For example, a user may gesture towards, or otherwise interact with, an AR marker displayed on their AR device 132. This may pull up a menu with the option to interact with the signal source. The user may also be able to select a user directly from a list of friends or nearby users. If a user does not want to interact with another device or user, the base module 114 may skip to step 236.

If the user wants to interact with another device or user, the base module 114 may initiate at step 230 the interaction request module 126. The interaction request module 126 may allow users to send requests to interact with other users and/or devices. Unregistered devices may still be sent interaction requests, which may be associated with the device until the owner of that device opts into the system 100. A user who receives an interaction request can accept or reject the request.

The base module 114 may determine at step 232 if the request to interact was accepted by the other user. If the interaction request module 126 returns that the interaction was accepted, then the base module 114 will determine that the interaction was accepted. If the interaction was not accepted, the base module 114 may skip to step 236.

If the interaction was accepted, the base module 114 may initiate at step 234 the connectivity module 128 and send interaction data. The connectivity module 128 may facilitate communication between two or more users once an interaction request has been accepted. The interaction data may contain the users and/or devices that have agreed to interact.

The base module 114 may initiate at step 236 the targeted ad module 130 and send in the tracking data. The targeted ad module 130 may send targeted advertisements to specific users based on their location. Ad targeting may take into account information about the location, such as the nearby points of interest 136, nearby AR devices 132 and non-AR devices 134, the user's movement speed and direction, other users in the area, or any other factor which may affect the relevance of an ad. The base module 114 may return at step 238 to step 202. The base module 114 may continue to loop until the wireless base station 102 is deactivated and/or powered down. In some loops, steps may be skipped to avoid redundancy, power consumption, and/or high computational load.

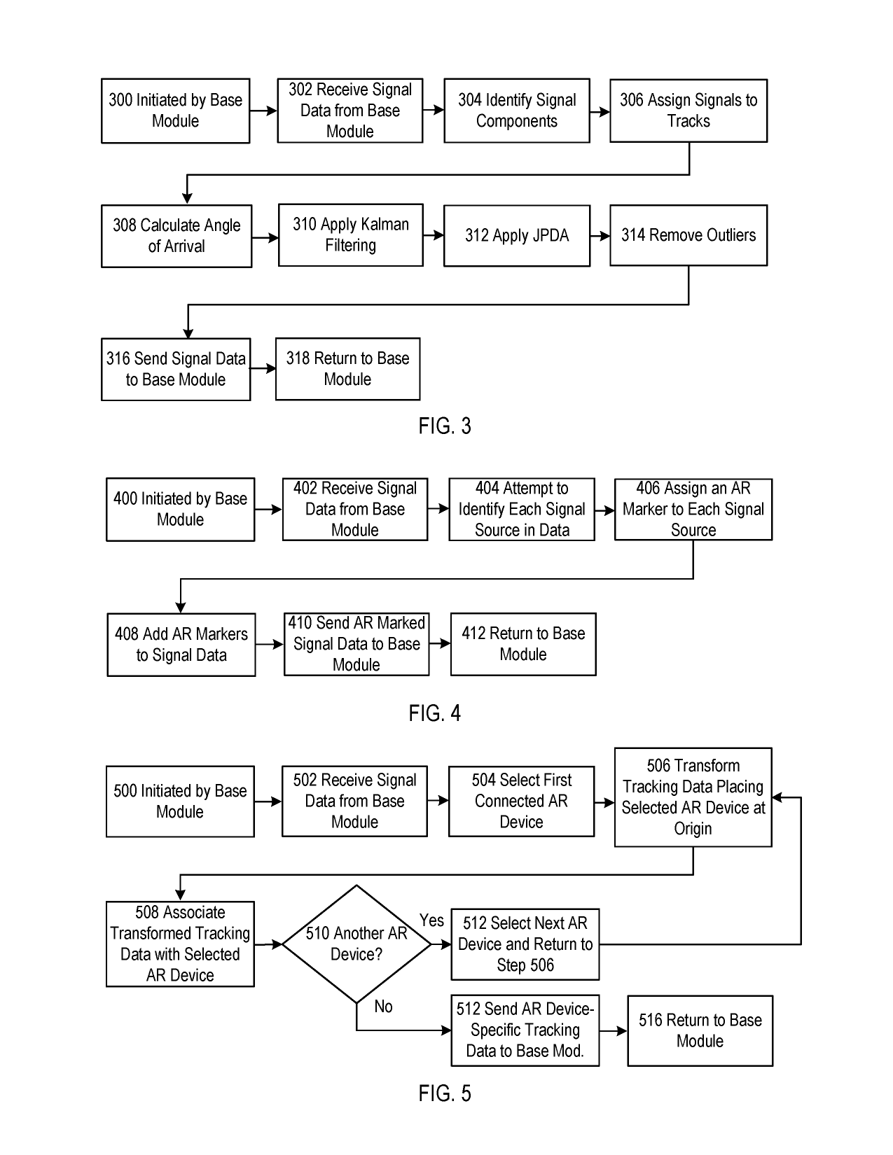

FIG. 3 illustrates an example operation of the XYZ position module 116. The XYZ position module 116 may be initiated at step 300 by the base module 114. The XYZ position module 116 may receive at step 302 signal data from the base module 114.

The XYZ position module 116 may identify at step 304 the components of the received signals. Identifying the components of a signal, such as a Wi-Fi signal, may involve various techniques and tools. The XYZ position module 116 may perform a frequency domain analysis using a Fast Fourier Transform (FFT). This converts the time-domain signal into its frequency components, allowing it to identify the carrier frequencies and any subcarriers. Tools like spectrum analyzers or SDR software can facilitate this process. The XYZ position module 116 may determine the modulation scheme used. Wi-Fi signals typically use Orthogonal Frequency Division Multiplexing (OFDM). Analyzing the signal's modulation involves examining the changes in amplitude, frequency, or phase that encode the data. This can be done using constellation diagrams and demodulation algorithms. The XYZ position module 116 may decode the higher-level protocol information. Wi-Fi signals conform to standards such as IEEE 802.11. Protocol analyzers or Wi-Fi sniffers can be used to interpret the protocol layers, extracting information such as MAC addresses, frame types, and payload data. Cellular signals typically use Quadrature Amplitude Modulation (QAM) and Phase Shift Keying (PSK). Cellular signals conform to standards such as LTE, GSM, and 5G. Protocol analyzers or cellular sniffers can be used to interpret the protocol layers, extracting information such as IMSI (International Mobile Subscriber Identity), cell tower identifiers, and data payload. Bluetooth signals typically use Gaussian Frequency Shift Keying (GFSK) and other modulation schemes like Phase Shift Keying (PSK) for enhanced data rates. Bluetooth signals conform to standards such as Bluetooth Core Specification. Protocol analyzers or Bluetooth sniffers can be used to interpret the protocol layers, extracting information such as device addresses, service records, and data payloads. Note that decryption of the data may not be required for the data components to be identified. Some signals, such as military signals, may have their components identified if the system 100 knows the modulation methods and protocols. These signals may be omitted from the public signal data.

The XYZ position module 116 may assign at step 306 the signals to tracks, associating new signals with existing tracks or creating new tracks. This involves analyzing the signal data and determining which signals correspond to which tracked signal source. The XYZ position module 116 may use criteria such as signal strength, frequency, phase, identifying data, and timing information to match signals to known tracks. If a signal does not match any existing track, a new track is created. This step is useful for organizing the signal data into coherent tracks that can be further analyzed and monitored.

The XYZ position module 116 may calculate at step 308 the angle of arrival (AoA) for each signal using phase and time delay data. This involves determining the direction from which each signal is arriving relative to the phased array. The XYZ position module 116 may use the phase differences and time delays between the signals received at different antennas to calculate the AoA. This step is useful for understanding the spatial orientation of the signal sources and is a component in triangulating their positions. For example, the signal data indicates that a 2.4GHz signal was received at antennas 1 and 2 of the phased antenna array 104. The signal was received 3 nanoseconds later at antenna 2, and the phase was shifted by 1 radian. Assume the antennas are 10cm apart. The path difference (Δd) can be calculated using the time delay using the equation Δd=c×Δt, where c is the speed of light in air. For a Δt value of 3 nanoseconds, the path difference is 9cm. The sine function of the AoA is equal to the path difference over the antenna separation, sin(AoA)= Δd/d. Evaluating this for a path distance of 9cm gives an AoA of approximately 1.12 radians. For another example, the signal data indicates that a 2.4GHz signal was received by antennas 3 and 4 of the phased antenna array 104. The signal was received 2 nanoseconds later at antenna 4, and the phase was shifted by 1 radian. Assume the antennas are 10 cm apart. The phase difference (Δ𝜙) can be converted to path difference (Δ𝑑) using Δd= (Δϕ⋅λ) / 2π. Where λ is the wavelength. Wavelength can be calculated from (λ) = c/f, where c is the speed of light and f is frequency. Since frequency is 2.4GHz, wavelength is 12.5cm. Plugging in the wavelength and phase difference gives a path difference of about 2cm. The sine function of the AoA is equal to the path difference over the antenna separation, sin(AoA)= Δd/d. Evaluating this for a path distance of 2cm gives an AoA of approximately 0.20 radians. Using multiple methods of calculating the AoA allows the XYZ position module 116 to check if all methods agree, and if not, to pick the most reliable method or approximate a value based on the answers of each method.

The XYZ position module 116 may apply at step 310 Kalman filtering to predict and update the state of tracked objects. The Kalman filter uses a series of measurements observed over time, containing statistical noise and other inaccuracies, to produce estimates of unknown variables. It operates in a two-step process: prediction and update. During the prediction step, the Kalman filter uses the current state estimate to predict the state at the next time step. During the update step, the filter incorporates new measurements to correct the state estimate. This process helps to smooth out the tracking data and provides more accurate estimates of the positions and velocities of tracked objects.

The XYZ position module 116 may apply at step 312 Joint Probabilistic Data Association (JPDA) to associate measurements with tracks probabilistically. JPDA is used in scenarios where there are multiple potential targets and measurements, and it is not clear which measurement corresponds to which target. The XYZ position module 116 may calculate the probabilities of each measurement being associated with each track and update the tracks based on these probabilities. This method helps to resolve ambiguities and improves the accuracy of tracking in complex environments with multiple signal sources.

The XYZ position module 116 may remove at step 314 outliers to ensure the accuracy of the tracking data. Outliers are measurements that deviate significantly from the expected values and can distort the tracking results. The XYZ position module 116 may use statistical analysis and predefined thresholds to identify and filter out these erroneous data points. By removing outliers, the system 100 improves the reliability and precision of the tracking data, ensuring that accurate and consistent measurements are used in the final tracking calculations.

The XYZ position module 116 may send at step 316 the finalized signal data to the base module 114. The signal data may include tracking data. This tracking data may include the calculated location of each signal source based on received signals. The data may also include metadata such as confidence level and margin of error. For example, the tracking data may include that an AR device 132 is at the coordinates (1348cm, 804cm, -52cm) and a non-AR device 134 is at the coordinates (1145m, 210cm, -30cm) where the origin (0,0,0) is the location of the wireless base station 102. The XYZ position module 116 may return at step 318 to the base module 114.

FIG. 4 illustrates an example operation of the AR marker module 118. The AR marker module 118 may be initiated at step 400 by the base module 114. The AR marker module 118 may receive at step 402 signal data from the base module 114.

The AR marker module 118 may attempt at step 404 to identify the source of each signal in the signal data. Identifying the source of a signal, especially distinguishing between devices like laptops and cellphones, and further identifying the specific device owner may involve several technical approaches. The signal carrier frequency may be used to identify the source of a signal. Different types of devices often operate at specific frequency bands, and analyzing these frequencies can provide useful information about the signal source. For example, Wi-Fi operates in the 2.4 GHz and 5 GHz bands, while cellular phones use bands ranging from 700 MHz to 2600 MHz and beyond, depending on the generation of technology (e.g., 3G, 4G, 5G). Bluetooth typically operates around 2.4 GHz. By analyzing the carrier frequency, the AR marker module 118 may narrow down the type of device. Each device connected to a network has a unique Media Access Control (MAC) address. By capturing the MAC address of a signal source, the AR marker module 118 may identify the type of device and sometimes the manufacturer. Network monitoring tools can be used to log the MAC addresses of connected devices. Device fingerprinting involves collecting and analyzing various attributes of a device, such as operating system version, browser type, installed applications, and hardware specifications. This can help distinguish between different types of devices (e.g., laptop vs. cellphone). Analyzing the protocols and ports used by the device can provide clues about its type. For instance, cell phones may use different sets of protocols and services compared to laptops. Tools like Wireshark can be used to inspect network traffic and infer device type. Devices often broadcast identifiable information over Wi-Fi and Bluetooth, such as SSID names and device names. Many devices require user authentication to access network services. By correlating login information with network traffic, the AR marker module 118 may identify the owner of a device. This can be done through network access control (NAC) systems, which enforce security policies and log user activities. Some devices generate logs that can be used to identify their type and the user. For example, system logs on a network can provide details about the devices that have accessed the network, including usernames and device types. Analyzing the behavior of network traffic can sometimes reveal patterns unique to specific users or devices. For instance, browsing habits, app usage patterns, and time-of-day activity can help identify a device and its user. By employing a combination of these methods, the AR marker module 118 may accurately identify the source of a signal, distinguish between different types of devices, and, in many cases, determine the specific user associated with each device.

The AR marker module 118 may assign at step 406 an AR marker to each identified signal source based on the identity of the source. For example, a cellphone belonging to a user of the system 100 may be marked as a "registered cellphone," and a laptop that is not registered with the system 100 may be marked as an "unregistered laptop." If the signal source is registered with the system 100, the AR marker may include data on the user. For example, the cellphone belonging to a user may be marked "registered cellphone - user#1234". Each AR marker may be associated with a graphical indicator that is displayed on the AR device 132 and linked to the signal source. For example, when the user looks in the direction of the cellphone belonging to user#1234, they may see a green phone icon hovering above the cellphone. The user may be able to interact with this cellphone icon using gestures or the interface of the AR device 132 and, view more details about user#1234 and send an interaction request. These icons may be stored locally on the AR device 132 and may be customizable by the user of an AR device 132. Unknown signal sources may also be associated with an icon, such as a question mark.

The AR marker module 118 may add at step 408 the AR markers to the received signal data. The AR marker module 118 may send at step 410 the signal data with the included AR markers to the base module 114. The AR marker module 118 may return at step 412 to the base module 114.

FIG. 5 illustrates an example operation of the spatial awareness module 120. The spatial awareness module 120 may be initiated at step 500 by the base module 114. The spatial awareness module 120 may receive at step 502 signal data from the base module 114.

The spatial awareness module 120 may select at step 504 a first connected AR device 132. This may be any of the AR devices 132 connected to the system 100.

The spatial awareness module 120 may transform at step 506 the tracking data in the signal data such that the selected AR device 132 is at the origin of the coordinates instead of the wireless base station 102. For example, the original tracking data included that the selected AR device 132 is at the coordinates (1348cm, 804cm, -52cm) and a non-AR device 134 is at the coordinates (1145m, 210cm, -30cm) where the origin (0,0,0) is the location of the wireless base station 102. The transformed tracking data would have the selected AR device 132 at the origin (0,0,0), the wireless base station at (-1348cm, -804cm, 52cm), and the non-AR device 134 at (-203cm, -594cm, 22cm). This transformation is a mathematical process, which often involves subtracting the coordinates of the selected AR device 132 from the coordinates of each signal source in the tracking data. With the selected AR device 132 placed at the origin, the AR device 132 can use the tracking data to quickly determine the direction and distance to each other signal source and the wireless base station 102. The spatial awareness module 120 may associate at step 508 the transformed tracking data with the selected AR device 132. The transformed tracking data is specific to the selected AR device 132, and the association of the two will allow the base module 114 to send the correct transformed tracking data to the selected AR device 132.

The spatial awareness module 120 may determine at step 510 if there is another AR device 132 that is connected to the system 100 and that has not yet been selected.

If there is another AR device 132, the spatial awareness module 120 may select at step 512 another AR device 132 and return to step 506.

If there are no other AR devices 132, the spatial awareness module 120 may send at step 514 the AR device 132 specific tracking data to the base module 114. This data includes the specific transformed tracking data for each connected AR device 132. This data can be used by the AR device 132 to find the location of other signal sources relative to the AR device 132. For example, using the AR specific tracking data, the AR device 132 may determine the location of each RFID tagged product nearby. When the AR device 132 is pointed at the product, the appropriate AR marker may be displayed, and the user may be able to easily find the product and read product details on the AR device 132 that may not be available in non-augmented reality. The spatial awareness module 120 may return at step 516 to the base module 114.

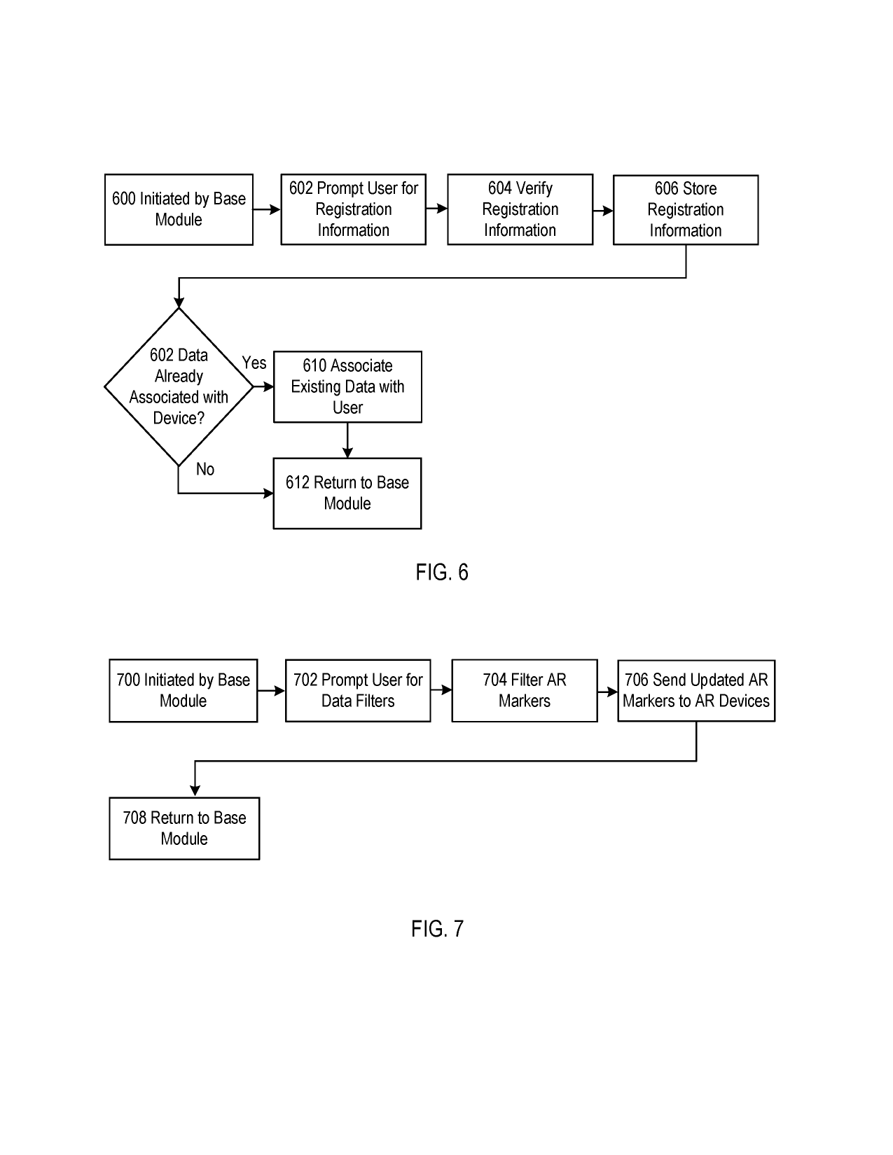

FIG. 6 illustrates an example operation of the opt-in module 122. The opt-in module 122 may be initiated at step 600 by the base module 114. The opt-in module 122 may prompt at step 602 the user to enter registration information. This involves displaying a user interface requesting details such as name, email address, and any other information for registering the device or service. The system 100 ensures that the user is aware of the information being requested and provides a method for the user to input this data. This step may use the interface of the AR device 132 or may be completed through a web portal or mobile application.

The opt-in module 122 may verify at step 604 the registration information. This step involves checking the entered data for accuracy and completeness. The opt-in module 122 may perform validation checks such as verifying the email format, ensuring mandatory fields are filled, and possibly cross-referencing the data with existing records to prevent duplication.

If any discrepancies or errors are found, the user is prompted to correct the information before proceeding. The opt-in module 122 may store at step 606 the registration information. Once the data has been verified, it is securely saved in the system's database. The storage process ensures that the information is encrypted and stored in compliance with data protection regulations. The system 100 confirms that the data has been successfully stored and is accessible for future reference or updates.

The data may be stored locally in memory 112 or may be uploaded to a network or cloud. The opt-in module 122 may determine at step 608 if there is data already associated with the user's device or devices. Since tracking data is collected from any signal source, data may be stored that is associated with unregistered devices. For example, a user may send a request to interact with an unregistered non-AR device 134, such as a person's smartphone. This request may be associated with the smartphone, but since the device is unregistered, the interaction request may not be delivered. If no past data is available, the opt-in module 122 may skip to step 612.

If there is already data associated with the user's device or devices, the opt-in module 122 may associate at step 610 the existing data with the user. For example, when the owner of a smartphone opts into the system 100 by registering, the data associated with the smartphone may now be linked with the new user. If a request to interact was sent before the registration, the request to interact may now be delivered. The new user may also be able to view past data regarding their device that was stored before they had registered, such as location data. The opt-in module 122 may return at step 612 to the base module 114.

FIG. 7 illustrates an example operation of the data filtering module 124. The data filtering module 124 may be initiated at step 700 by the base module 114. The data filtering module 124 may prompt at step 702 the user for data filters. For example, the user may be able to select from a list of tags such as "friends," "nearby," "AR devices," "sports fans," "places of interest," etc. Tags may be combined to further filter the data. In an embodiment, a user may select filters from their AR device 132 using gestures such as pointing to an AR marker.

The data filtering module 124 may filter at step 704 the AR marker data based on the data filter selected by the user. For example, if the user selected "friends," then only devices that are associated with that user's friends should have AR markers, and all other signal sources or places of interest 136 are filtered out. The data filtering module 124 may send at step 706 the updated AR marker data to the AR device 132 so that only AR markers for the unfiltered devices can be seen by the user. The data filtering module 124 may return at step 708 to the base module 114.

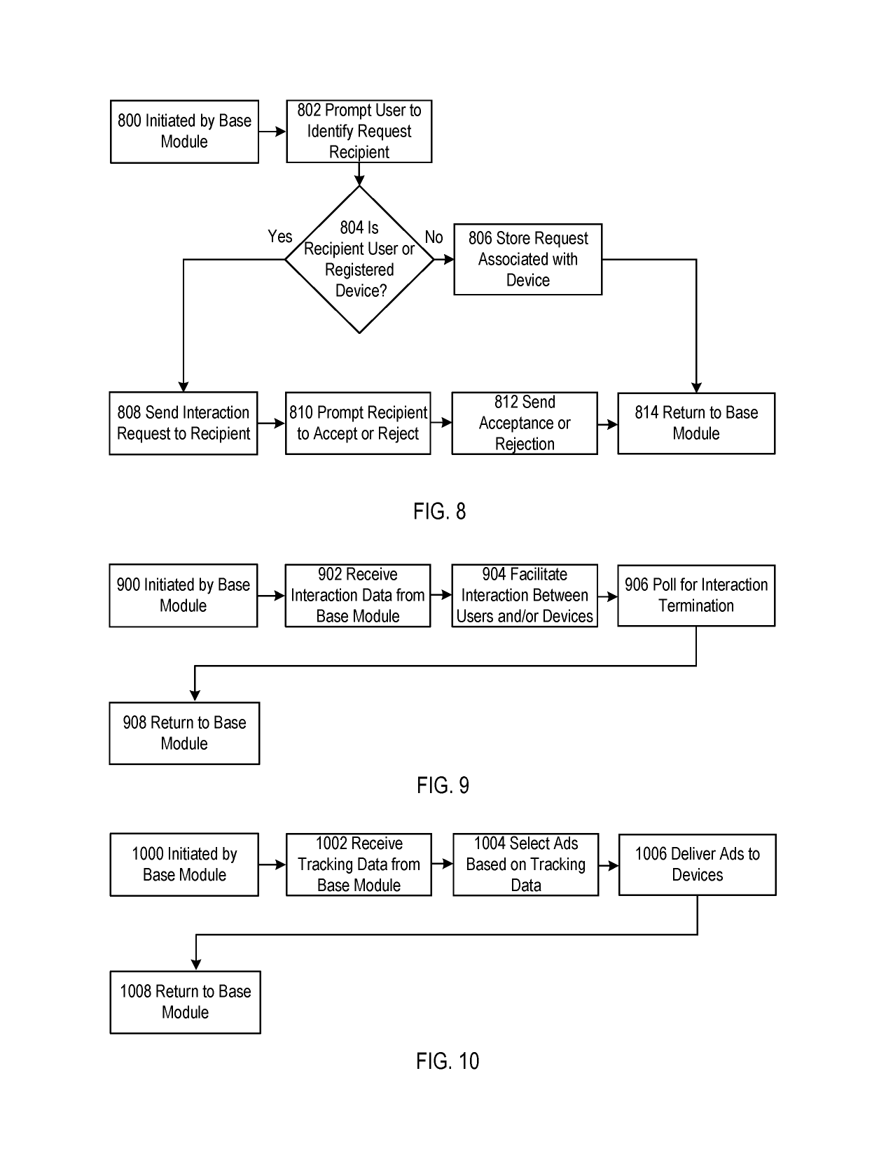

FIG. 8 illustrates an example operation of the interaction request module 126. The interaction request module 126 may be initiated at step 800 by the base module 114. The interaction request module 126 may prompt at step 802 the user to identify a request recipient. For example, a user may select a friend from a list of friends or gesture at an AR marker and select a "message" option from a dropdown menu. More than one request recipient may be identified.

The interaction request module 126 may determine at step 804 if the recipient of the interaction request is a user or a device registered with the system 100. A user may be selected via a friend list or contact list, whereas a device may be selected by gesturing at or selecting an AR marker associated with that device.

If the interaction request recipient is an unregistered device, the interaction request module 126 may store at step 806 the request in memory 112 and associate it with the unregistered device. If the device is registered at a later time via the opt-in module 122, the interaction request may be delivered. The interaction request module 126 may then skip to step 814.

If the interaction request recipient is a user or a registered device, the interaction request module 126 may send at step 808 an interaction request to the recipient device or user. If the recipient is a user, they may receive the request on any device that is connected to their account.

The interaction request module 126 may prompt at step 810 to accept or reject the interaction request. For example, a prompt may read "Bob wants to chat" and give the user the option to accept or reject. The prompt may give further detail on how the interaction request was sent. For example, if the recipient device is an AR device 132, the AR marker for Bob's device may be highlighted so that the recipient may be able to identify Bob in a crowded area. The interaction request module 126 may send at step 812 the acceptance or rejection of the interaction request to the base module 114. The interaction request module 126 may return at step 814 to the base module 114.

FIG. 9 illustrates an example operation of the connectivity module 128. The connectivity module 128 may be initiated at step 900 by the base module 114. The connectivity module 128 may receive at step 902 interaction data from the base module 114. The interaction data may contain the users and/or devices that have agreed to interact.

The connectivity module 128 may facilitate at step 904 interaction between the users and/or devices. For example, the connectivity module 128 may allow users to send text messages to each other, may allow the devices to sync up for games, may allow the users to view each other's profile information, etc. The connectivity module 128 may continue to facilitate interaction until one user or device terminates the interaction.

The connectivity module 128 may poll at step 906 for a user or device to terminate the interaction. Interaction data may be stored in memory 112 or locally on the devices so that the interaction can be continued at another time. The connectivity module 128 may return at step 908 to the base module 114.

FIG. 10 illustrates an example operation of the targeted ad module 130. The targeted ad module 130 may be initiated at step 1000 by the base module 114. The targeted ad module 130 may receive at step 1002 tracking data from the base module 114. Tracking data may include the calculated location of each signal source based on received signals.

The targeted ad module 130 may select at step 1004 ads based on tracking data. With the ability to know the location of every transmitting device within an area, targeted ad selection can be significantly enhanced by leveraging real-time data and proximity-based strategies. The targeted ad module 130 may send personalized notifications to devices that enter a specific area. For example, if a user enters a store or a specific section of a shopping mall, they could receive ads or promotions relevant to that location. The targeted ad module 130 may use historical data and patterns associated with the detected devices to tailor advertisements. For example, if a user frequently visits electronics stores, they might receive targeted ads for the latest gadgets or special offers from nearby tech shops. The targeted ad module 130 may display ads relevant to the current context and location of the user. If a user is near a restaurant around lunchtime, they might receive promotions or discounts for meals. Similarly, ads can be tailored for events, like offering concert ticket discounts when a user is near a venue. The targeted ad module 130 may use AR to create interactive advertisements that appear when users point their devices at certain locations or objects. For example, pointing an AR device 132 at a store could display ongoing sales or new product launches through AR overlays. The targeted ad module 130 may update digital billboards and signage dynamically based on the detected audience within the vicinity. This allows for real-time changes in advertisements to match the interests and demographics of the people nearby. During events or gatherings, the targeted ad module 130 may tailor advertisements based on the collective interests of the crowd. For example, at a sports event, ads could promote related merchandise, upcoming games, or food and beverage deals. The targeted ad module 130 may analyze the location data to create heatmaps showing areas with high foot traffic. Use this information to place physical advertisements or promotional stands in optimal locations to maximize visibility and engagement. The targeted ad module 130 may display ads for a couple or group of friends based on the proximity of other devices. For example, if two devices have been within a foot of each other for more than 10 minutes, both devices may receive ads for dinner deals or date ideas. The targeted ad module 130 may tailor ads based on detected active tags on nearby products. Viewing or passing by-products with active tags could trigger these ads, which may change the AR marker of the product to catch a user's attention. Active tags near other non-AR devices 134, such as a cellphone, may indicate that a product has been purchased by the user of that cellphone. This may cause the targeted ad module 130 to direct ads to that user based on their purchase history.

The targeted ad module 130 may deliver at step 1006 the ads to the relevant devices. AR devices 132 may receive AR versions of advertisements, while non-AR devices 134 may be limited to traditional advertisements. The targeted ad module 130 may return at step 1008 to the base module 114.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A system comprising:
a phased antenna array;
a position module configured to:
receive, from the phased antenna array, signals from one or more signal sources in an environment; and
determine, based on the signals, a location of each of the one or more signal sources in the environment relative to the phased antenna array;
an augmented reality (AR) marker module configured to:
identify each of the one or more signal sources for which identifying data is available; and
assign an AR marker to each of the one or more signal sources to produce AR-marked signal data;
a spatial awareness module configured to:
calculate a spatial position of each of the one or more signal sources with respect to at least one AR device; and
associate the spatial position of each of the one or more signal sources with the at least one AR device to produce AR device-specific tracking data; and
a communication interface configured to transmit the AR-marked signal data and the AR device-specific tracking data to the at least one AR device for generation of an AR display.

2. The system of claim 1, wherein the position module determines the location of the one or more signal sources by triangulation and/or trilateration.

3. The system of claim 1, wherein the position module utilizes at least one of a Kalman filter, a Joint Probabilistic Data Association (JPDA) operation, or a Multiple Signal Classification (MUSIC) algorithm to determine the location of each of the one or more signal sources.

4. The system of claim 1, wherein the position module is configured to identify signal components of the signals from the one or more signal sources and assign the signals to tracks.

5. The system of claim 1, wherein the AR marker visually indicates information about at least one attribute of a respective signal source and is associated with graphical indicator that is displayed on a respective AR device.

6. The system of claim 1, wherein at least a subset of the one or more signal sources are registered devices, and wherein the phased antenna array is configured to connect to each registered device.

7. The system of claim 1, further comprising a registration module configured to:
in response to a request for a new registration from a user of the at least one AR device:
prompt the user for registration information; and
store the registration information in association with the at least one AR device.

8. The system of claim 1, further comprising a filter module configured to:
prompt a user for at least one data filter; and
filter the AR-marked signal data based on the at least one data filter before displaying one or more associated AR markers in the AR display.

9. The system of claim 1, wherein the at least one AR device includes a first AR device and a second AR device, the system further comprising an interaction request module configured to:
prompt a user of the first AR device for a recipient;
identify the second AR device based on the recipient;
send an interaction request to the recipient at the second AR device; and
receive an acceptance or rejection of the interaction request.

10. The system of claim 9, the system further comprising a connectivity module configured to initiate interaction between the first AR device and the second AR device in response to receipt of the acceptance.

11. A method comprising:
receiving, from a phased antenna array, signals from one or more signal sources in an environment;
determining, based on the signals, a location of each of the one or more signal sources in the environment relative to the phased antenna array;
identifying each of the one or more signal sources for which identifying data is available;
assigning an AR marker to each of the one or more signal sources to produce AR-marked signal data;
calculating a spatial position of each of the one or more signal sources with respect to at least one AR device;
associating the spatial position of each of the one or more signal sources with the at least one AR device to produce AR device-specific tracking data; and
transmitting, via a communication interface, the AR-marked signal data and the AR device-specific tracking data to the at least one AR device for generation of an AR display.

12. The method of claim 11, wherein determining the location of each of the one or more signal sources includes determining the location of each of the one or more signal sources using triangulation and/or trilateration.

13. The method of claim 11, wherein determining the location of each of the one or more signal sources includes using at least one of a Kalman filter, a Joint Probabilistic Data Association (JPDA) operation, or a Multiple Signal Classification (MUSIC) algorithm to determine the location of each of the one or more signal sources.

14. The method of claim 11, wherein determining the location of each of the one or more signal sources includes:
identify signal components of the signals from the one or more signal sources; and
assigning the signals to tracks.

15. The method of claim 11, wherein the AR marker visually indicates information about at least one attribute of a respective signal source and is associated with graphical indicator that is displayed on a respective AR device.

16. The method of claim 11, wherein at least a subset of the one or more signal sources are registered devices, and wherein the method includes connecting to each registered device via the phased antenna array.

17. The method of claim 11, further comprising:
in response to a request for a new registration from a user of the at least one AR device:
prompting the user for registration information; and
storing the registration information in association with the at least one AR device.

18. The method of claim 11, further comprising:
prompting a user for at least one data filter; and
filtering the AR-marked signal data based on the at least one data filter before displaying one or more associated AR markers in the AR display.

19. The method of claim 11, wherein the at least one AR device includes a first AR device and a second AR device, the method further including:
prompting a user of the first AR device for a recipient;
identifying the second AR device based on the recipient;
sending an interaction request to the recipient at the second AR device; and
receiving an acceptance or rejection of the interaction request.

20. The method of claim 19, further comprising initiating interaction between the first AR device and the second AR device in response to receipt of the acceptance.
